(19) United States
(12) Patent Application Publication
(10) Pub. No.: US 2014/0001678 A1
(43) Pub. Date: Jan. 2, 2014

(54) METHOD FOR MANUFACTURING LIQUID CRYSTAL POLYESTER MOLDED BODIES

(71) Applicants: Tomoyuki Hara, Tsukuba-shi (JP); Mitsuo Maeda, Tsukuba-shi (JP); Yasuo Matsumi, Tsukuba-shi (JP)

(72) Inventors: Tomoyuki Hara, Tsukuba-shi (JP); Mitsuo Maeda, Tsukuba-shi (JP); Yasuo Matsumi, Tsukuba-shi (JP)

(73) Assignee: SUMITOMO CHEMICAL COMPANY, LIMITED, Tokyo (JP)

(21) Appl. No.: 14/005,468

(22) PCT Filed: Mar. 13, 2012
(86) PCT No.: PCT/JP2012/056426

§ 371 Date: Sep. 16, 2013

(30) Foreign Application Priority Data
Mar. 22, 2011 (JP) 2011-062436

(51) Int. Cl. B29C 45/00

(52) U.S. Cl. CPC B29C 45/0001
USPC 264/328.14

(57) ABSTRACT

A method is provided for manufacturing a liquid crystal polyester molded body by molding a liquid crystal polyester composition using a molding machine containing a cylinder, a screw and a heater. The screw is provided inside the cylinder, and is composed of a feed section, a compression section, and a metering section, the feed section and the compression section of the screw are composed of a single flight, the heater is provided on the outer periphery of the cylinder. The liquid crystal polyester composition contains a liquid crystal polyester and a polyamide resin. The method for manufacturing the polyester molded body includes: a step of melting and metering the liquid crystal polyester composition, a step of tightening a mold and performing mold clamping, a step of injecting the melted liquid crystal polyester composition into the mold, and a step of extracting the solidified resin from inside the mold.

### TECHNICAL FIELD

The present invention relates to a method for manufacturing liquid crystal polyester molded bodies. Priority is claimed on Japanese Patent Application No. 2011-062436, filed Mar. 22, 2011, the content of which is incorporated herein by reference.

### BACKGROUND ART

Liquid crystal polyester compositions exhibit excellent melt flowability, and, depending on their structure, have thermal deformation resistance at temperatures of 300° C. or higher, and they have therefore been used as molding materials for manufacturing electrical and electronic components such as OA and AV components, but in recent years, investigations are also being conducted into the use of liquid crystal polyester compositions as molding materials for manufacturing large components for vehicles and aircraft and the like.

Injection molding or extrusion molding is generally used as the method for molding a liquid crystal polyester composition. Ensuring that the time required for the metering step (the plasticization time) is constant in injection molding, or ensuring that the discharge volume is constant in extrusion molding, requires that the liquid crystal polyester composition is plasticized in a stable manner

In the extrusion molding of a liquid crystal polyester composition, if a typical screw used in the extrusion molding of a general-purpose resin such as propylene is used, then as a result of the difference in the shear rate in the kneading section, and the fact that the viscosity of the composition decreases only in those portions where heat is transmitted from the walls of the cylinder, a large difference in viscosity develops for the resin inside the cylinder, which can cause discharge faults and makes the plasticization difficult to stabilize, and therefore a technique that uses a full flight type screw having prescribed groove diameters for the metering section and the feed section has been disclosed (see Patent Document 1).

### DOCUMENTS OF RELATED ART

### Patent Documents

Patent Document 1: JP-2001-162670-A

### SUMMARY OF THE INVENTION

### Problems to be Solved by the Invention

However, particularly in the case of large molding machines, even if a liquid crystal polyester composition is molded using a full flight type screw, the plasticization is difficult to stabilize, and therefore warping of the molded body and fluctuations in the dimensions tend to occur. Further, because plasticization tends to take a long time, meaning the resin has a long residence time inside the molding machine, other problems such as gas generation also occur.

The present invention has been developed in light of the above circumstances, and has an object of providing a method for manufacturing liquid crystal polyester molded bodies which enables a liquid crystal polyester composition to be plasticized and molded in a stable manner

### Means to Solve the Problems

In order to achieve the above object, the present invention has the following aspects.

A first aspect of the present invention is a method for manufacturing a liquid crystal polyester molded body by molding a liquid crystal polyester composition using a molding machine comprising a cylinder, a screw and a heater, wherein

the screw is provided inside the cylinder, and is composed of a feed section, a compression section, and a metering section,

the feed section and the compression section of the screw are composed of a single flight,

the heater is provided on the outer periphery of the cylinder, the liquid crystal polyester composition comprises a liquid crystal polyester and a polyamide resin, and

the method for manufacturing the polyester molded body comprises:

a step of melting and metering the liquid crystal polyester composition,

a step of tightening a mold and performing mold clamping,

a step of injecting the melted liquid crystal polyester composition into the mold, and

a step of extracting the solidified resin from the inside of the mold.

A second aspect of the present invention is the method for manufacturing a liquid crystal polyester molded body according to the first aspect, wherein the spacing between the screw and the cylinder of the molding machine is from 0.1 to 0.25 mm.

A third aspect of the present invention is the method for manufacturing a liquid crystal polyester molded body according to the first or second aspect, wherein the screw is a full flight screw.

A fourth aspect of the present invention is the method for manufacturing a liquid crystal polyester molded body according to any one of the first to third aspects, wherein the liquid crystal polyester composition comprises 0.005 to 1.0 parts by weight of the polyamide resin per 100 parts by weight of the combination of all the components of the composition besides the polyamide resin.

### Effect of the Invention

The present invention can provide a method for manufacturing liquid crystal polyester molded bodies which enables a liquid crystal polyester composition to be plasticized and molded in a stable manner

### BRIEF DESCRIPTION OF THE DRAWINGS

FIG. 1 is a schematic cross-sectional view illustrating an injection molding machine that is suitable for use in the present invention.

### EMBODIMENTS OF THE INVENTION

The present invention is described below in further detail.

The method for manufacturing a liquid crystal polyester molded body according to the present invention is a method for manufacturing a liquid crystal polyester molded body by molding a liquid crystal polyester composition using a molding machine comprising a cylinder, a screw and a heater, wherein the feed section and the compression section of the screw are composed of a single flight, and the liquid crystal polyester composition comprises a liquid crystal polyester and a polyamide resin.

The liquid crystal polyester is a liquid crystal polyester that exhibits liquid crystallinity in a molten state, and preferably melts at a temperature of 450° C. or lower. The liquid crystal polyester may also be a liquid crystal polyesteramide, a liquid crystal polyester ether, a liquid crystal polyester carbonate, or a liquid crystal polyesterimide. The liquid crystal polyester is preferably a fully aromatic liquid crystal polyester obtained using only aromatic compounds as the raw material monomers.

Typical examples of the liquid crystal polyester include:

(I) those obtained by polymerizing (polycondensing) an aromatic hydroxycarboxylic acid, an aromatic dicarboxylic acid, and at least one compound selected from the group consisting of aromatic diols, aromatic hydroxyamines and aromatic diamines,

(II) those obtained by polymerizing a plurality of aromatic hydroxycarboxylic acids,

(III) those obtained by polymerizing an aromatic dicarboxylic acid and at least one compound selected from the group consisting of aromatic diols, aromatic hydroxyamines and aromatic diamines, and

(IV) those obtained by polymerizing a polyester such as polyethylene terephthalate and an aromatic hydroxycarboxylic acid.

Here, each of the aromatic hydroxycarboxylic acids, aromatic dicarboxylic acids, aromatic diols, aromatic hydroxyamines and aromatic diamines may, independently, be partially or completely replaced with a polymerizable derivative thereof.

The compounds having a carboxyl group such as the aromatic hydroxycarboxylic acid and the aromatic dicarboxylic acid may be polymerizable derivatives thereof, and examples of these polymerizable derivatives include compounds (esters) in which the carboxyl group has been converted to an alkoxycarbonyl group or an acyloxycarbonyl group, compounds (acid halides) in which the carboxyl group has been converted to a haloformyl group, and compounds (acid anhydrides) in which the carboxyl group has been converted to an acyloxycarbonyl group.

The compounds having a hydroxyl group such as the aromatic hydroxycarboxylic acid, the aromatic diol and the aromatic hydroxyamine may be polymerizable derivatives thereof, and examples of these polymerizable derivatives include compounds (acylated compounds) in which the hydroxyl group has been acylated and converted to an acyloxy group.

The compounds having an amino group such as the aromatic hydroxyamine and the aromatic diamine may be polymerizable derivatives thereof, and examples of these polymerizable derivatives include compounds (acylated compounds) in which the amino group has been acylated and converted to an acylamino group.

Examples of the aromatic hydroxycarboxylic acid include para-hydroxybenzoic acid, meta-hydroxybenzoic acid, 2-hydroxy-6-naphthoic acid, 2-hydroxy-3-naphthoic acid, 1-hydroxy-5-naphthoic acid, 4-hydroxy-4′-carboxydiphenyl ether, and aromatic hydroxycarboxylic acids in which a portion of the hydrogen atoms on the aromatic ring(s) of these aromatic hydroxycarboxylic acids have each been substituted with a substituent selected from the group consisting of alkyl groups, awl groups and halogen atoms. In the production of the liquid crystalline polyester, these aromatic hydroxycarboxylic acids may be used individually, or 2 or more may be combined.

Examples of the aromatic dicarboxylic acid include terephthalic acid, isophthalic acid, biphenyl-4,4′-dicarboxylic acid, 2,6-naphthalenedicarboxylic acid, diphenyl ether-4,4′-dicarboxylic acid, diphenyl thioether-4,4′-dicarboxylic acid, and aromatic dicarboxylic acids in which a portion of the hydrogen atoms on the aromatic ring(s) of these aromatic dicarboxylic acids have each been substituted with a substituent selected from the group consisting of alkyl groups, awl groups and halogen atoms. In the production of the liquid crystalline polyester, these aromatic dicarboxylic acids may be used individually, or 2 or more may be combined.

Examples of the aromatic diol include 4,4′-dihydroxybiphenyl, hydroquinone, resorcinol, 4,4′-dihydroxydiphenyl ketone, 4,4′-dihydroxydiphenyi ether, bis(4-hydroxyphenyl)methane, 1,2-bis(4-hydroxyphenyl)ethane, 4,4′-dihydroxydiphenyl sulfone, 4,4′-dihydroxydiphenyl thioether, 2,6-dihydroxynaphthalene, 1,5-dihydroxynaphthalene, and aromatic diols in which a portion of the hydrogen atoms on the aromatic ring(s) of these aromatic diols have each been substituted with a substituent selected from the group consisting of alkyl groups, aryl groups and halogen atoms. In the production of the liquid crystalline polyester, these aromatic diols may be used individually, or 2 or more may be combined.

Specific examples of the aromatic hydroxyamine and the aromatic diamine include 4-aminophenol, 4-acetamidophenol, 1,4-phenylenediamine, N-methyl-1,4-phenylenediamine, N,N′-dimethyl-1,4-phenylenediamine, 3-aminophenol, 3-methyl-4-aminophenol, 2-chloro-4-aminophenol, 4-amino-1-naphthol 4-amino-4′-hydroxydiphenyl, 4-amino-4′-hydroxydiphenyl ether, 4-amino-4′-hydroxydiphenylmethane 4-amino-4′-hydroxydiphenyl sulfide, 4,4′-diaminophenyl sulfide (also called thiodianiline), 4,4′-diaminodiphenyl sulfone, 2,5-diaminotoluene, 4,4′-ethylenedianiline, 4,4′-diaminodiphenoxyethane, 4,4′-diaminodiphenylmethane (also called methylenedianiline), and 4,4′-diaminodiphenyl ether (also called oxydianiline). Examples of ester derivatives and/or amide derivatives of these aromatic hydroxyamines and aromatic diamines include acetyl derivatives and propionyl derivatives. In the production of the liquid crystalline polyester, these aromatic hydroxyamines and aromatic diamines may be used individually, or 2 or more may be combined.

The liquid crystal polyester preferably has a repeating unit represented by general formula (1) shown below (hereafter sometimes referred to as “the repeating unit (1)”), and more preferably has the repeating unit (1), a repeating unit represented by general formula (2) shown below (hereafter sometimes referred to as “the repeating unit (2)”), and a repeating unit represented by general formula (3) shown below (hereafter sometimes referred to as “the repeating unit (3)”).

[Chemical Formula 1]

[Chemical Formula 2]

[Chemical Formula 3]

In the above formulas, Ar¹ represents a phenylene group, a naphthylene group or a biphenylylene group; each of Ar² and Ar³ independentlyrepresents a phenylene group, a naphthylene group, a biphenylylene group or a group represented by general formula (4) shown below; each of X and Y independently represents an oxygen atom or an imino group; and one or more hydrogen atoms in Ar¹, Ar² and Ar³ may each be independently substituted with a halogen atom, a linear or branched alkyl group or an aryl group.

[Chemical Formula 4]

In the formula, each of Ar⁴ and Ar³ independently represents a phenylene group or a naphthylene group; and Z represents an oxygen atom, a sulfur atom, a carbonyl group, a sulfonyl group or an alkylidene group.

Examples of the aforementioned halogen atom include a fluorine atom, a chlorine atom, a bromine atom and an iodine atom.

Examples of the linear or branched alkyl group include a methyl group, ethyl group, n-propyl group, isopropyl group, n-butyl group, isobutyl group, sec-butyl group, tert-butyl group, n-pentyl group, n-hexyl group, n-heptyl group, 2-ethylhexyl group, n-octyl group, n-nonyl group and n-decyl group, and the carbon number of the group is preferably from 1 to 10.

Examples of the awl group include a phenyl group, o-tolyl group, m-tolyl group, p-tolyl group, 1-naphthyl group and 2-naphthyl group, and the carbon number of the group is preferably from 6 to 20.

When the aforementioned hydrogen atoms are substituted with these substituents, the number of substituents per individual group represented by Ar¹, Ar² or Ar³ is preferably two or fewer, and more preferably one.

Examples of the alkylidene group include a methylene group, ethylidene group, isopropylidene group, n-butylidene group and 2-ethylhexylidene group, and the carbon number of the group is preferably from 1 to 10.

The repeating unit (1) is a repeating unit derived from a prescribed aromatic hydroxycarboxylic acid. The repeating unit (1) is preferably a unit in which Ar¹ represents a p-phenylene group (a repeating unit derived from p-hydroxybenzoic acid), or a unit in which Ar³ represents a 2,6-naphthylene group (a repeating unit derived from 6-hydroxy-2-naphthoic acid).

The repeating unit (2) is a repeating unit derived from a prescribed aromatic dicarboxylic acid. The repeating unit (2) is preferably a unit in which Ar² represents a p-phenylene group (a repeating unit derived from terephthalic acid), a unit in which Ar² represents an m-phenylene group (a repeating unit derived from isophthalic acid), a unit in which Ar² represents a 2,6-naphthylene group (a repeating unit derived from 2,6-naphthalenedicarboxylic acid), or a unit in which Ar² represents a diphenyl ether-4,4′-diyl group (a repeating unit derived from diphenyl ether-4,4′-dicarboxylic acid).

The repeating unit (3) is a repeating unit derived from a prescribed aromatic diol, aromatic hydroxyamine or aromatic diamine. The repeating unit (3) is preferably a unit in which Ar³ represents a p-phenylene group (a repeating unit derived from hydroquinone, p-aminophenol or p-phenylenediamine), or a unit in which Ar³ represents a 4,4′-biphenylylene group (a repeating unit derived from 4,4′-dihydroxybiphenyl, 4-amino-4′-hydroxybiphenyl or 4,4′-diaminobiphenyl).

The amount of the repeating unit (1), relative to the total amount of all the repeating units that constitute the liquid crystal polyester (the value obtained by determining the molar equivalent weight (mol) of each of the repeating units that constitutes the liquid crystal polyester by dividing the weight of each repeating unit by the formula weight of the repeating unit, and then totaling those molar equivalent weights), is preferably 30 mol % or greater, more preferably 30 to 80 mol %, still more preferably 40 to 70 mol %, and particularly preferably 45 to 65 mol %.

The amount of the repeating unit (2), relative to the total amount of all the repeating units that constitute the liquid crystal polyester, is preferably 35 mol % or less, more preferably 10 to 35 mol %, still more preferably 15 to 30 mol %, and particularly preferably 17.5 to 27.5 mol %.

The amount of the repeating unit (3), relative to the total amount of all the repeating units that constitute the liquid crystal polyester, is preferably 35 mol % or less, more preferably 10 to 35 mol %, still more preferably 15 to 30 mol %, and particularly preferably 17.5 to 27.5 mol %.

The larger the amount of the repeating unit (1), the more easily the melt flowability, the heat resistance, and the strength and rigidity can be improved, but if the amount is too large, then the melting temperature and the melt viscosity tend to increase, and the temperature required for molding tends to increase.

The ratio between the amount of the repeating unit (2) and the amount of the repeating unit (3) is represented by [amount of repeating unit (2)]/[amount of repeating unit (3)] (mol/mol), and is preferably from 0.9/1 to 1/0.9, more preferably from 0.95/1 to 1/0.95, and still more preferably from 0.98/1 to 1/0.98.

The liquid crystal polyester may contain two or more types of each of the repeating units (1) to (3). Further, the liquid crystal polyester may also include other repeating units besides the repeating units (1) to (3), but the amount of such other repeating units, relative to the total amount of all the repeating units that constitute the liquid crystal polyester, is preferably 10 mol % or less, and more preferably 5 mol % or less.

The liquid crystal polyester preferably has a repeating unit (3) in which X and Y both represent oxygen atoms, namely a repeating unit derived from a prescribed aromatic diol, and more preferably contains only units in which X and Y both represent oxygen atoms as the repeating unit (3). By using such a composition, the melt viscosity of the liquid crystal polyester tends to decrease.

The liquid crystal polyester is preferably produced by performing a melt polymerization of the raw material monomers corresponding with the repeating units that constitute the liquid crystal polyester, and subjecting the thus obtained polymer (prepolymer) to a solid phase polymerization. This enables a high-molecular weight liquid crystal polyester having superior heat resistance, strength and rigidity to be produced with good operability. The melt polymerization may be performed in the presence of a catalyst, and in such cases, examples of the catalyst include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino)pyridine and 1-methylimidazole. Nitrogen-containing heterocyclic compounds can be used particularly favorably.

The liquid crystal polyester has a flow starting temperature that is preferably at least 270° C., more preferably 270° C. to 400° C., and still more preferably 280° C. to 380° C. The higher the flow starting temperature, the more easily the heat resistance and the strength and rigidity can be improved, but if the flow starting temperature is too high, then the melting temperature and the melt viscosity tend to increase, and the temperature required for molding the liquid crystal polyester tends to increase.

The flow starting temperature is also referred to as the flow temperature or the fluidizing temperature, is measured using a capillary rheometer, is the temperature at which the viscosity reaches 4,800 Pa·s (48,000 poise) when the liquid crystal polyester is melted and extruded from a nozzle having an internal diameter of 1 mm and a length of 10 mm under a loading of 9.8 MPa (100 kgf/cm²) and at a rate of temperature increase of 4° C./minute, and acts an indicator of the molecular weight of the liquid crystal polyester (see page 95 of “Liquid Crystal Polymers—Synthesis•Molding•Applications—”, edited by Naoyuki Koide, published by CMC Publishing Co., Ltd., Jun. 5, 1987).

Examples of the aforementioned polyamide resin include aliphatic polyamide resins such as nylon-6, nylon-4,6, nylon-6,6, nylon-11, nylon-12 and nylon-6,12; semi-aromatic polyamide resins such as nylon-6T and nylon-9T; fully aromatic polyamide resins such as alternating copolymers of phenylenediamine units and terephthalic acid units; polyesteramide resins; and polyamideimide resins, and these resins may be used individually, or 2 or more may be combined. Among these possibilities, from the viewpoint of achieving more stable plasticization, the polyamide resin is preferably an aliphatic polyamide resin.

The melting point of the polyamide resin is preferably 30° C. or higher, more preferably 50° C. or higher, and particularly preferably 100° C. or higher. When the melting point is 30° C. or higher, volatilization of a portion of the polyamide resin during preliminary drying of the liquid crystal polyester composition prior to molding is suppressed, and the plasticization is more stable.

The polyamide resin is preferably in powder form, and in such cases, the average particle size of the polyamide resin is preferably 100 μm or less, and more preferably 50 μm or less. By using a powdered polyamide resin having an average particle size of 100 μm or less, mixing with the liquid crystal polyester is easier, and the plasticization becomes more stable.

Besides the aforementioned liquid crystal polyester and polyamide resin, the liquid crystal polyester composition may, where necessary, also contain one or more other components such as fillers, additives, and resins other than liquid crystal polyesters.

The filler may be a fibrous filler, a plate-like filler, or another filler other than a fibrous or plate-like filler. Examples of these other fillers include particulate fillers such as spherical fillers.

Further, the filler may be an inorganic filler or an organic filler.

Examples of fibrous inorganic fillers include glass fiber; carbon fiber such as PAN-based carbon fiber and pitch-based carbon fiber; ceramic fiber such as silica fiber, alumina fiber and silica-alumina fiber; and metal fiber such as stainless steel fiber. Further examples include whiskers such as potassium titanate whiskers, barium titanate whiskers, wollastonite whiskers, aluminum borate whiskers, silicon nitride whiskers and silicon carbide whiskers.

Examples of fibrous organic fillers include polyester fiber and aramid fiber.

Examples of plate-shaped inorganic fillers include talc, mica, graphite, wollastonite, glass flakes, barium sulfate and calcium carbonate. The mica may be muscovite, phlogopite, fluorphlogopite or tetrasilic mica.

Examples of particulate inorganic fillers include silica, alumina, titanium oxide, glass beads, glass balloons, boron nitride, silicon carbide and calcium carbonate.

The amount of the filler relative to 100 parts by weight of the liquid crystal polyester is preferably from 0 to 100 parts by weight.

Examples of the additives include leveling agents, antifoaming agents, antioxidants, heat stabilizers, ultraviolet absorbers, antistatic agents, surfactants, flame retardants and colorants, and the amount of such additives is preferably 0 to 5 parts by weight per 100 parts by weight of the liquid crystal polyester.

Examples of the resins other than liquid crystal polyesters include thermoplastic resins such as polypropylene, polyester other than liquid crystal polyesters, polysulfone, polyphenylene sulfide, polyetherketone, polycarbonate, polyethersulfone, polyphenylene ether and polyetherimide; and thermosetting resins such as phenol resin, epoxy resin, polyimide resin and cyanate resin, and the amount of such resins is preferably 0 to 20 parts by weight per 100 parts by weight of the liquid crystal polyester.

The liquid crystal polyester composition is obtained by mixing the liquid crystal polyester, the polyamide resin, and any other components that are used as necessary, at a temperature not higher than the flow starting temperature of the liquid crystal polyester. Further, an extruder may be used to melt-knead and then pelletize the liquid crystal polyester and any other components that are used as necessary, with these pellets then being mixed with the polyamide resin. There are no particular limitations on the mixing method, provided that the mixing is performed at a temperature not higher than the flow starting temperature, and examples include methods in which mixing is performed using a Henschel mixer or a tumbler or the like, either at room temperature or in a heated enviromnent.

In the liquid crystal polyester composition, the amount of the polyamide resin, relative to 100 parts by weight of the combination of all the components of the composition besides the polyamide resin, is preferably from 0.005 to 1.0 parts by weight, more preferably from 0.005 to 0.2 parts by weight, and particularly preferably from 0.01 to 0.02 parts by weight. In other words, in the case where, for example, the liquid crystal polyester composition comprises only the liquid crystal polyester and the polyamide resin, the amount of the polyamide resin is preferably from 0.005 to 1.0 parts by weight per 100 parts by weight of the liquid crystal polyester. In the case where the liquid crystal polyester composition comprises the liquid crystal polyester, the polyamide resin and other component(s), the amount of the polyamide resin is preferably from 0.005 to 1.0 parts by weight per 100 parts by weight of the combination of the liquid crystal polyester and the other component(s).

By ensuring that the amount of the polyamide resin is 1.0 parts by weight or less, gas generation caused by decomposition of the polyamide resin itself during molding processing is suppressed, and the occurrence of swelling in the molded body is better suppressed. Further, ensuring that the amount of the polyamide resin is at least 0.005 parts by weight yields better stability of the plasticization.

A melt molding method such as an injection molding method or extrusion molding method is employed as the molding method for the liquid crystal polyester composition. The injection molding method may be an injection compression molding method. Examples of the extrusion molding method include a blow molding method, an inflation molding method and a T-die molding method.

The molding machine comprises a cylinder, a screw and a heater. The screw is provided inside the cylinder, and is composed of a feed section (supply section), a compression section, and a metering section (measuring section). Further, the heater is provided on the outer periphery of the cylinder, and in those cases where a plurality of heaters are provided, the temperature of each heater can preferably be adjusted independently.

The screw is formed so that the feed section and the compression section are composed of a single flight. Examples of preferred screw configurations include screws in which a portion of the metering section is composed of a sub-flight (barrier flight) or mixing flight, and the other region is composed of the single flight, and full flight screws (full single flight screws) in which all of the metering section is composed of the single flight. Among these, in terms of achieving more favorable flow of the liquid crystal polyester composition inside the cylinder, a full flight screw is preferable.

The spacing (A) between the screw and the cylinder is preferably from 0.1 to 0.25 mm. A spacing of at least 0.1 mm enables contact between the screw and the cylinder to be inhibited in a stable manner. Further, a spacing of 0.25 mm or less enables reverse flow of melted liquid crystal polyester composition from the front end of the screw toward the back end of the screw to be prevented in a stable manner, resulting in more stable plasticization. Here, the “spacing between the screw and the cylinder” refers to the shortest distance between the outermost surface of the screw and the inner surface of the cylinder, and typically refers to the shortest distance between the outermost surface of each of the screw ridges and the inner surface of the cylinder.

The length (L₁) of the feed section of the screw in the central axis direction is preferably 40 to 60% of the length (L_{A}) of the entire screw in the central axis direction. When this type of range is satisfied, the heat of the heater can be transmitted satisfactorily to all of the liquid crystal polyester composition in the compression section, resulting in more stable plasticization. In the present description, unless specifically stated otherwise, the “length of the screw” refers to the “length of the screw in the central axis direction”.

The length (L₂) of the compression section of the screw in the central axis direction is preferably 10 to 45%, and more preferably 25 to 40%, of the length (L_{A}) of the entire screw in the central axis direction. When this type of range is satisfied, the plasticization is more stable.

The screw compression ratio is preferably from 1.3 to 3.0, and more preferably from 1.5 to 2.5. When the ratio is at least 1.3, the liquid crystal polyester composition tends to melt more easily, whereas when the ratio is 3.0 or less, rapid compression of the liquid crystal polyester composition is suppressed, resulting in more stable plasticization. Here, the “compression ratio” refers to the ratio between the flow path volume of one pitch of the feed section and the flow path volume of one pitch of the metering section.

In the screw, the value (P/D) obtained by dividing the screw pitch (P) by the screw outer diameter (D) is preferably from 0.8 to 1.2. When this type of range is satisfied, the heat of the heater can be transmitted satisfactorily to all of the liquid crystal polyester composition, resulting in more stable plasticization.

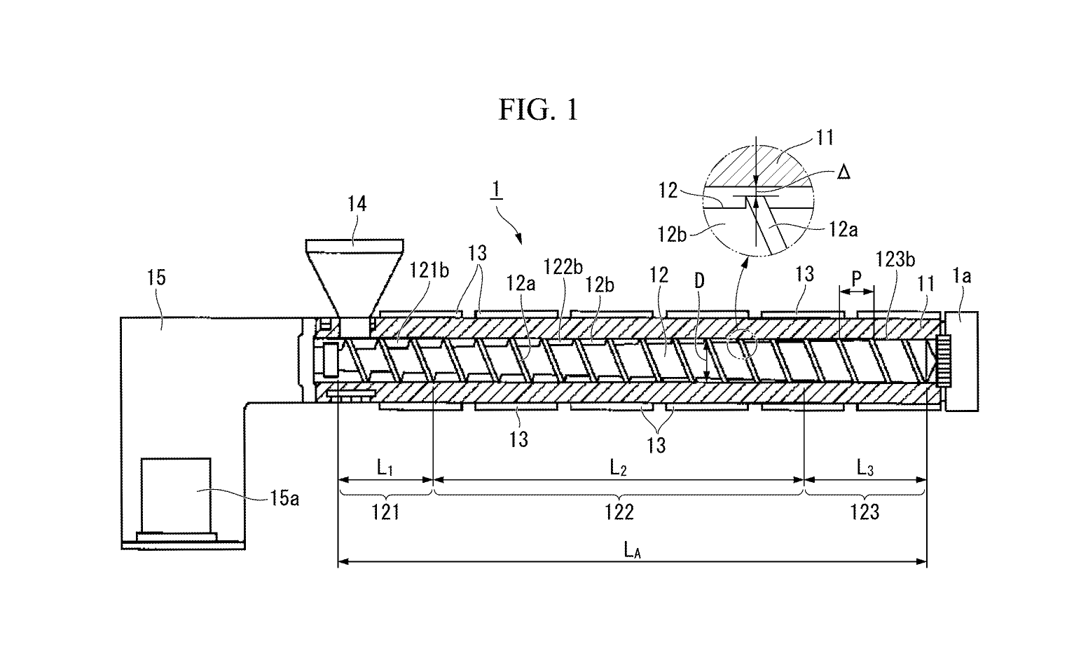

FIG. 1 is a schematic cross-sectional view illustrating an injection molding machine that is suitable for use in the present invention.

The illustrated molding machine 1 comprises a substantially cylindrical cylinder 11, and a uniaxial screw 12 provided thereinside.

The screw 12 is rotationally driven by a drive unit 15 equipped with a motor 15a.

The cylinder 11 is provided with a hopper 14 for supplying the liquid crystal polyester composition into the cylinder at a location near the back end of the screw 12. Further, a plurality of heaters 13, which are independently temperature adjustable, are installed on the outer periphery of the cylinder 11 along the central axis direction of the cylinder.

The screw 12 is a full flight screw in which a single helical flight 12a is provided with a constant pitch from the back end toward the front end, and a helical screw channel 12b is formed by the flight 12a. The flight 12a corresponds with the screw ridges, and the screw channel 12b corresponds with the screw recesses.

The screw 12 (length: L_{A}) is composed of a feed section 121 (length: L₁), a compression section 122 (length: L₂) and a metering section 123 (length: L₃), in that order from the back end toward the front end.

Along the central axis direction, the outer diameter D of the screw 12 is constant, and the spacing α between the screw 12 and the cylinder 11 is also constant. Further, the pitch P of the screw is also constant.

On the other hand, the diameter of the screw channel 121b in the feed section and the diameter of the screw channel 123b in the metering section 123 are each constant along the central axis direction, but the diameter of the screw channel 123b is larger than the diameter of the screw channel 121b. The diameter of the screw channel 122b in the compression section 122 increases continuously from the side of the feed section 121 toward the side of the metering section 123.

According to the molding machine 1, the liquid crystal polyester composition supplied from the hopper 14 to the inside of the cylinder 11 is heated by the heaters 13, melt-kneaded by the screw 12 which is driven rotationally by the drive unit 15, and then ejected from the front end 1a of the molding machine 1.

The molding machine 1 is illustrated merely as an example of a machine that is suitable for use in the present invention, and the molding machine is not limited to this configuration.

One example of a method for manufacturing a liquid crystal polyester molded body is a manufacturing method having a step of melting and metering the liquid crystal polyester composition, a step of tightening a mold and performing mold clamping, a step of injecting the melted liquid crystal polyester composition into the mold, and a step of extracting the solidified resin from the inside of the mold.

Examples of the mechanism used for tightening the mold include a toggle system in which a toggle mechanism is used to perform opening and closing of the mold and mold clamping, and a direct pressure system in which a hydraulic cylinder or the like is used to perform mold clamping directly.

When a large item is injection molded, a molding machine having a large mold clamping force is preferable from the viewpoint of moldability, and the mold clamping force is preferably at least 4,500 kN, and more preferably 5,500 kN or greater.

Examples of the applications of the liquid crystal polyester molded body include reflectors such as a lamp reflector or LED reflector, holders such as a lamp holder or heater holder, a coil bobbin, hark disk drive components, food dishes such as ovenware, vehicle components, aircraft components, semiconductor jigs, and automobile components.

According to the present invention, by using a screw in which the feed section and the compression section are composed of a single flight, and using a liquid crystal polyester composition containing a polyamide resin, plasticization can be stabilized even when the liquid crystal polyester composition is molded using a large molding machine, and therefore fluctuations in the shape and dimensions of the molded bodies is suppressed. Further, because the composition is not exposed to a long residence time inside the molding machine, decomposition is suppressed, and gas generation is also suppressed.

### EXAMPLES

The present invention is described below in further detail using a series of specific examples. However, the present invention is in no way limited by the examples presented below.

In the following examples, the flow starting temperature of the liquid crystal polyester and the amount of gas generated by the molded body were measured using the respective methods described below.

### (Measurement of Flow Starting Temperature of Liquid Crystal Polyester)

Using a flow tester (model: CFT-500, manufactured by Shimadzu Corporation), approximately 2 g of the liquid crystal polyester was packed in a cylinder fitted with a die having an internal diameter of 1 mm and a length of 10 mm, and the temperature at which the viscosity reached 4,800 Pa·s (48,000 poise) when the liquid crystal polyester was melted and extruded from the nozzle under a loading of 9.8 MPa (100 kgf/cm²) and at a rate of temperature increase of 4° C./minute was measured.

### (Measurement of Amount of Generated Gas)

The molded body was cut, a 4 g sample was weighed accurately, and following washing with distilled water, the sample was placed in a 25 ml vial that had been vacuum dried, and the vial was then sealed with packing composed of polytetrafluoroethylene and then for 20 hours inside a hot air dryer set to a temperature of 150° C. to cause gas generation from the molded body. This vial was mounted in a headspace gas chromatograph (GC-15A/HSS-3A, manufactured by Shimadzu Corporation), and with the temperature maintained at 120° C., the generated gas was injected into a column (length 50 m×diameter 0.25 mm) using HR-1701 (manufactured by Shinwa Chemical Industries Ltd.) as a packing material. At the same time as the injection, the column temperature was held at 40° C. for 5 minutes, was subsequently increased to 280° C. at 10° C./minute, and was then held for 5 minutes, and the total amount of gas generated from the start until the 34 minutes had elapsed was detected using a detector. An FID-type detector was used as the detector, and helium was used as the carrier gas.

### <Production of Liquid Crystal Polyester>

### Production Example 1

A reactor fitted with a stirrer, a torque meter, a nitrogen gas inlet tube, a thermometer and a reflux condenser was charged with p-hydroxybenzoic acid (994.5 g, 7.2 mol), terephthalic acid (299.1 g, 1.8 mol), isophthalic acid (99.7 g, 0.6 mol), 4,4′-dihydroxybiphenyl (446.9 g, 2.4 mol), acetic anhydride (1347.6 g, 13.2 mol) and 0.2 g of 1-methylimidazole, the mixture was stirred under a stream of nitrogen gas while the temperature was increased from room temperature to 150° C. over a period of 30 minutes, and the mixture was then refluxed at 150° C. for 1 hour. Next, 0.9 g of 1-methylimidazole was added, the temperature was increased to 320° C. over a period of 2 hours and 50 minutes while the acetic acid by-product and unreacted acetic anhydride were removed by distillation, the temperature was held at 320° C. until an increase in torque was confirmed, and the contents were then removed from the reactor and allowed to cool to room temperature. The thus obtained solid material was ground in a grinder to obtain a powdered prepolymer. Subsequently, this prepolymer was subjected to a solid phase polymerization in a nitrogen gas atmosphere, by heating the prepolymer from room temperature to 250° C. over a period of 1 hour, increasing the temperature from 250° C. to 285° C. over a period of 5 hours, and then holding the temperature at 285° C. for 3 hours, and the product was then cooled to obtain a powdered liquid crystal polyester. The flow starting temperature of this liquid crystal polyester was 327° C.

### <Production of Liquid Crystal Polyester Composition>

### Production Example 2

Following mixing of 85 parts by weight of the liquid crystal polyester obtained in production example 1 and 15 parts by weight of carbon fiber (TCTR-03158, manufactured by Mitsubishi Rayon Co., Ltd.), the mixture was granulated using a biaxial extruder (model: PCM30, manufactured by Ikegai Corporation) at a cylinder temperature of 340° C., thus obtaining a composition. To 100 parts by weight of the thus obtained composition was added 0.02 parts by weight of a polyamide resin (VESTOSINT 2070, manufactured by Daicel Degussa Ltd.), and mixing was performed using a tumbler to obtain a liquid crystal polyester composition 1.

### Production Example 3

With the exception of not using the polyamide resin, a liquid crystal polyester composition IR was obtained using the same method as Production Example 2.

### Production Example 4

With the exception of using 0.0075 parts by weight of SUMILIZER GP (manufactured by Sumitomo Chemical Co., Ltd.) and 0.0075 parts by weight of ARMOSLIP E (manufactured by Lion Corporation) instead of the polyamide resin, a liquid crystal polyester composition 2R was obtained using the same method as Production Example 2.

### <Manufacture of Liquid Crystal Polyester Molded Bodies>

### Example 1

The liquid crystal polyester composition 1 was molded into a box-shaped molded body (400 mm×300 mm×100 mm, thickness 3 mm) using an injection molding machine (J650AD, manufactured by The Japan Steel Works, Ltd., clamping force: 6,500 kN) and a screw 1 (screw outer diameter: 92 mm, ratio between total screw length and screw outer diameter: 22, compression ratio: 1.7, P/D: 1, length of feed section: 50% of total screw length, length of compression section: 40% of total screw length, length of metering section: 10% of total screw length, screw structure: full flight screw, spacing between the screw and the cylinder: 0.2 mm) at a cylinder temperature of 360° C. and a mold temperature of 95° C., and the plasticization time was measured for 10 shots. Further, the amount of gas generated by the box-shaped molded body was measured.

### Example 2

With the exception of using a screw 2 (screw outer diameter: 84 mm, ratio between total screw length and screw outer diameter: 22, compression ratio: 1.7, PID: 1, length of feed section: 50% of total screw length, length of compression section: 40% of total screw length, length of metering section: 10% of total screw length, screw structure: a screw in which the feed section and the compression section are composed of a single flight, and having two sub-flights in the metering section, spacing between the screw and the cylinder: 0.2 mm) instead of the screw 1, the plasticization time and the amount of generated gas were measured using the same method as Example 1.

### Comparative Example 1

With the exception of using the liquid crystal polyester composition IR instead of the liquid crystal polyester composition 1, the plasticization time and the amount of generated gas were measured using the same method as Example 1.

### Comparative Example 2

With the exception of using the liquid crystal polyester composition 2R instead of the liquid crystal polyester composition 1, the plasticization time and the amount of generated gas were measured using the same method as Example 1.

### Comparative Example 3

With the exception of using the liquid crystal polyester composition 1R instead of the liquid crystal polyester composition 1, the plasticization time and the amount of generated gas were measured using the same method as Example 2.

### Comparative Example 4

With the exception of using the liquid crystal polyester composition 2R instead of the liquid crystal polyester composition 1, the plasticization time and the amount of generated gas were measured using the same method as Example 2.

### Comparative Example 5

With the exception of using a screw 3 (screw outer diameter: 92 mm, ratio between total screw length and screw outer diameter: 22, compression ratio: 1.4, P/D: 0.8, length of feed section: 60% of total screw length, length of compression section: 15% of total screw length, length of metering section: 25% of total screw length, screw structure: a screw in which the feed section has a single flight, the compression section has one sub-flight, and the metering section has one sub-flight, spacing between the screw and the cylinder: 0.2 mm) instead of the screw 1, the plasticization time and the amount of generated gas were measured using the same method as Example 1.

### Comparative Example 6

With the exception of using the liquid crystal polyester composition 1R instead of the liquid crystal polyester composition 1, the plasticization time and the amount of generated gas were measured using the same method as Comparative Example 5.

### Comparative Example 7

With the exception of using the liquid crystal polyester composition 2R instead of the liquid crystal polyester composition 1, the plasticization time and the amount of generated gas were measured using the same method as Comparative Example 5.

The constituent components and the composition ratio of each of the produced liquid crystal polyester compositions are shown in Table 1, the main structural features of the screws used are shown in Table 2, and the main manufacturing conditions, the plasticization time and the amount of generated gas for each of the liquid crystal polyester molded bodies are shown in Table 3.

[Table 1]

[Table 2]

[Table 3]

As is evident from the above results, in Examples 1 and 2, the plasticization time was short and stable, the composition did not have a long residence time inside the molding machine, and the amount of generated gas was able to be suppressed.

In contrast, in Comparative Examples 1 and 3 which used the liquid crystal polyester composition IR that did not contain a polyamide resin, although the same molding machine as Examples 1 and 2 was used, the plasticization time was long and unstable.

Further, in Comparative Examples 2 and 4, which used the liquid crystal polyester composition 2R containing SUMILIZER GP and the like which are known to have a plasticization time stabilizing effect instead of the polyamide resin, although the same molding machine as Examples 1 and 2 was used, the plasticization time was long and unstable, and the amount of generated gas was also unable to be suppressed.

Furthermore, in Comparative Example 5 which used the screw 3 in which the compression section was not composed of a single flight, although the same liquid crystal polyester composition 1 as Examples 1 and 2 was used, the plasticization time was long and unstable. Moreover, in Comparative Example 6 which used the same liquid crystal polyester composition 1R as Comparative Examples 1 and 3, and Comparative Example 7 which used the same liquid crystal polyester composition 2R as Comparative Examples 2 and 4, the plasticization time was even longer and more unstable. In this manner, only Examples 1 and 2, which used the liquid crystal polyester composition 1 and either the screw 1 or 2, exhibited the remarkable effects of stability of the plasticization time and favorable suppression of the amount of generated gas.

### INDUSTRIAL APPLICABILITY

The present invention can be used widely, from electrical and electronic components through to the manufacture of large components for vehicles and aircraft and the like, and is particularly suitable for the manufacture of large components.

### DESCRIPTION OF THE REFERENCE SIGNS

1: Molding machine
11: Cylinder
12: Screw
12a: Flight
121: Feed section
122: Compression section
13: Heater
Δ: Spacing between screw and cylinder

[Chemical Formula 1]

—O—Ar¹—CO— (1)

[Chemical Formula 2]

—CO—Ar²—CO— (2)

[Chemical Formula 3]

—X—Ar³—Y— (3)

[Chemical Formula 4]

—Ar⁴—Z—Ar⁵— (4)

TABLE 1

| | Constituent components |
|---|---|
| | and ratio (parts by weight) |
| Liquid crystal polyester composition 1 | liquid crystal polyester/carbon |
| | fiber/polyamide resin |
| | (85/15/0.02) |
| Liquid crystal polyester composition | liquid crystal polyester/carbon |
| 1R | fiber (85/15) |
| Liquid crystal polyester composition | liquid crystal polyester/carbon |
| 2R | fiber/Sumilizer GP/Armoslip E |
| | (85/15/0.0075/.0075) |

TABLE 2

| | | | | | | Spacing |
|---|---|---|---|---|---|---|
| | | | | | | between |
| | | | | Length relative to | | screw |
| | | | | total screw length (%) | | and |
| | | Compression | | Feed | Compression | cylinder |
| | Screw structure | ratio | P/D | section | section | (mm) |
| Screw 1 | Feed section; single flight | 1.7 | 1 | 50 | 40 | 0.2 |
| | Compression section: single | | | | | |
| | flight | | | | | |
| | Metering section: single | | | | | |
| | flight | | | | | |
| Screw 2 | Feed section: single flight | 1.7 | 1 | 50 | 40 | 0.2 |
| | Compression section: single | | | | | |
| | flight | | | | | |
| | Metering section: 2 sub- | | | | | |
| | flights | | | | | |
| Screw 3 | Feed section: single flight | 1.4 | 0.8 | 60 | 15 | 0.2 |
| | Compression section: 1 | | | | | |
| | sub-flight | | | | | |
| | Metering section: 1 sub- | | | | | |
| | flight | | | | | |

TABLE 3

| | Liquid | | | | | |
|---|---|---|---|---|---|---|
| | crystal | | | | | |
| | poly- | | Clamp- | Plasticization | | |
| | ester | | ing | time (seconds) | | Amount of |
| | compo- | | force | Aver- | Standard | generated |
| | sition | Screw | (kN) | age | deviation | gas (ppm) |
| Example 1 | 1 | 1 | 6500 | 23.2 | 1.1 | 9 |
| Comparative | 1R | 1 | 6500 | 60.1 | 26.9 | 7 |
| Example 1 | | | | | | |
| Comparative | 2R | 1 | 6500 | 65.0 | 19.0 | 24 |
| Example 2 | | | | | | |
| Example 2 | 1 | 2 | 6500 | 32.0 | 1.9 | 9 |
| Comparative | 1R | 2 | 6500 | 72.0 | 5.8 | 7 |
| Example 3 | | | | | | |
| Comparative | 2R | 2 | 6500 | 51.5 | 6.2 | 24 |
| Example 4 | | | | | | |
| Comparative | 1 | 3 | 6500 | 42.7 | 3.0 | 9 |
| Example 5 | | | | | | |
| Comparative | 1R | 3 | 6500 | 66.4 | 31.0 | 7 |
| Example 6 | | | | | | |
| Comparative | 2R | 3 | 6500 | 57.8 | 4.0 | 24 |
| Example 7 | | | | | | |

1. A method for manufacturing a liquid crystal polyester molded body by molding a liquid crystal polyester composition using a molding machine comprising a cylinder, a screw and a heater, wherein
the screw is provided inside the cylinder, and is composed of a feed section, a compression section, and a metering section,
the feed section and the compression section of the screw are composed of a single flight,
the heater is provided on an outer periphery of the cylinder,
the liquid crystal polyester composition comprises a liquid crystal polyester and a polyamide resin, and
the method for manufacturing a polyester molded body comprises:
a step of melting and metering the liquid crystal polyester composition,
a step of tightening a mold and performing mold clamping,
a step of injecting the melted liquid crystal polyester composition into the mold, and
a step of extracting the solidified resin from inside the mold.

2. The method for manufacturing a liquid crystal polyester molded body according to claim 1, wherein a spacing between the screw and the cylinder of the molding machine is from 0.1 to 0.25 mm.

3. The method for manufacturing a liquid crystal polyester molded body according to claim 1, wherein the screw is a full flight screw.

4. The method for manufacturing a liquid crystal polyester molded body according to claim 1, wherein the liquid crystal polyester composition comprises 0.005 to 1.0 parts by weight of the polyamide resin per 100 parts by weight of a combination of all components of the composition besides the polyamide resin.
